(19) United States
(12) Patent Application Publication
(10) Pub. No.: US 2022/0288954 A1
(43) Pub. Date: Sep. 15, 2022

(54) INKJET PRINTING METHOD AND INKJET PRINTING APPARATUS

(71) Applicant: HONDA MOTOR CO., LTD., Tokyo (JP)

(72) Inventors: Takaaki NAGATA, Tokyo (JP); Atsushi YUSA, Tokyo (JP); Daichi TAKANO, Tokyo (JP); Hisashi MASUDA, Tokyo (JP); Kazuhiro KAWANO, Tokyo (JP); Takahiro WATANABE, Tokyo (JP)

(21) Appl. No.: 17/678,016

(22) Filed: Feb. 23, 2022

(30) Foreign Application Priority Data
Mar. 9, 2021 (JP) 2021-037375

(51) Int. Cl. B41J 11/00; B41J 2/21

(52) U.S. Cl. CPC B41J 11/00214; B41J 2/2107

(57) ABSTRACT

An inkjet printing method is an inkjet printing method of printing by discharging droplets of UV curable ink onto a print target from an inkjet head, the method including: a normal printing step of forming at least one color layer on the print target; a first decimated printing step of discharging the droplets of the UV curable ink so as to form, on the color layer, one unlevel layer where a plurality of bumps are arranged at an interval equal to or more than a diameter of each of the droplets of the UV curable ink; and a second decimated printing step of stacking, on the bumps of the unlevel layer, at least one unlevel layer formed by discharging droplets of the UV curable ink so as to be overlaid thereon.

This application is based on and claims the benefit of priority from Japanese Patent Application No. 2021-037375, filed on 9 Mar. 2021, the content of which is incorporated herein by reference.

### BACKGROUND OF THE INVENTION

### Field of the Invention

The present invention relates to an inkjet printing method and an inkjet printing apparatus.

### Related Art

Conventionally, techniques of coloring a paint material or a print target, such as an instrument panel of an automobile, having irregularities on the surface have been known. The literature describing techniques of such a type includes Patent Document 1, for example. Patent Document 1 describes a technique of forming a coating film layer over the entire surface of an instrument panel on which a three-dimensional decorative part is formed, and subsequently removing only a coating film layer that covers the three-dimensional decorative part with laser beams to improve the appearance quality.
Patent Document 1: Japanese Unexamined Patent Application, Publication No. 2007-269221

### SUMMARY OF THE INVENTION

Patent Document 1 can improve the appearance quality of the paint material, but requires a step of removing the coating film layer, which covers the three-dimensional decorative part, after painting the entire surface of the paint material. There is a room for improvement in terms of efficient printing.

Here, an inkjet printing method of printing a print target using active energy ray curable ink, which is cured by irradiation with UV or the like, has been known. The inkjet printing method can effectively print the print target. However, in a case of printing a print target having irregularities on a surface, an inkjet head cannot get close to the surface of the print target in comparison with a case of a print target having a flat surface. The active energy ray curable ink is required to be discharged from a distant position. In a case where the distance from the inkjet head to the print target is large and droplets of the active energy ray curable ink are small, landing positions tend to deviate due to the air resistance and the like affecting the droplets before they reach from the inkjet head to the print target. If the droplets of the active energy ray curable ink are large, the droplets can fly straight a longer distance. However, there is a possibility that the droplets adhering to the surface of the print target are moistened and spread and are coupled with adjacent droplets to increase the gloss.

The present invention has an object to provide an inkjet printing method and an inkjet printing apparatus that can effectively form a printed surface with a reduced gloss on a print target having irregularities on a surface.

The present invention relates to an inkjet printing method for printing by discharging droplets of active energy ray curable ink onto a print target from an inkjet head, the method including: a normal printing step of forming at least one color layer on the print target; a first decimated printing step of discharging the droplets of the active energy ray curable ink so as to form, on the color layer, one unlevel layer having a plurality of bumps arranged at an interval equal to or more than a diameter of each of the droplets of the active energy ray curable ink; and a second decimated printing step of stacking, on the bumps of the unlevel layer, at least one unlevel layer formed by discharging droplets of the active energy ray curable ink such that the droplets are overlaid on the bumps.

The printing area of the print target may have an elongated shape, and the active energy ray curable ink may be discharged to the printing area while the inkjet head is moved in a longitudinal direction of the printing area.

The inkjet head may be movable in a reciprocating manner in the longitudinal direction, the first decimated printing step may include forming the one unlevel layer while moving the inkjet head in the longitudinal direction in a one-way manner, and the second decimated printing step may include forming the one unlevel layer every movement of the inkjet head in the longitudinal direction in the one-way manner.

The inkjet head may include a plurality of nozzles that are arranged in parallel in a predetermined direction and discharge the active energy ray curable ink, and the first decimated printing step and the second decimated printing step may each include using a predetermined number of the nozzles among the plurality of nozzles to form the unlevel layer while moving the inkjet head in the longitudinal direction of the printing area in a state where the predetermined direction is substantially parallel to a lateral direction of the printing area.

The normal printing step, the first decimated printing step and the second decimated printing step may each include using a robot arm capable of holding the print target and moving the robot arm holding the print target such that the area on which the inkjet head is able to print covers the printing area.

The active energy ray curable ink may be monochromatic.

The print target may be an instrument panel of an automobile.

The present invention relates to an inkjet printing apparatus, including: a printer configured to perform printing by discharging active energy ray curable ink to a print target; and a controller configured to control the printer, wherein the controller controls operation of the printer to: form at least one color layer on the print target; discharge the droplets of the active energy ray curable ink so as to form, on the color layer, one unlevel layer where a plurality of bumps are arranged at an interval equal to or more than a diameter of each of the droplets of the active energy ray curable ink; and stack, on the bumps of the unlevel layer, at least one unlevel layer formed by discharging droplets of the active energy ray curable ink such that the droplets are overlaid on the bumps.

The present invention can provide an inkjet printing method and an inkjet printing apparatus that can effectively form a printed surface with a reduced gloss on a print target having irregularities on a surface.

### BRIEF DESCRIPTION OF THE DRAWINGS

FIG. 1 is a sectional view of a printed matter printed by an inkjet printing method according to one embodiment of the present invention;

FIG. 2 shows the relationship between the 60° gloss of the printed matter and the average height Rc and the droplet pitch;

FIG. 3 is a block diagram showing an electric configuration of the inkjet printing apparatus according to one embodiment of the present invention;

FIG. 4 is a plan view of an inkjet head of the inkjet printing apparatus according to one embodiment of the present invention and a print target, and shows situations before start of a first decimated printing step;

FIG. 5A is a sectional view of a print target before printing in the inkjet printing method according to one embodiment of the present invention;

FIG. 5B is a sectional view of the print target on which foundation layers are printed in the inkjet printing method according to one embodiment of the present invention;

FIG. 5C is a sectional view of the print target on which a color layer is printed in the inkjet printing method according to one embodiment of the present invention;

FIG. 5D is a sectional view of a print target on which a first unlevel layer is printed in a decimated manner by a first decimated printing step in the inkjet printing method according to one embodiment of the present invention;

FIG. 5E is a sectional view of a print target on which a second unlevel layer is printed in a decimated manner by a second decimated printing step in the inkjet printing method according to one embodiment of the present invention;

FIG. 5F is a sectional view of a print target on which a fourth unlevel layer is printed in a decimated manner by the second decimated printing step in the inkjet printing method according to one embodiment of the present invention;

FIG. 6A is a plan view showing situations before formation of an unlevel layer on a print target by a conventional inkjet printing method; and

FIG. 6B is a plan view showing situations in the middle of forming an unlevel layer on a print target by a conventional inkjet printing method.

### DETAILED DESCRIPTION OF THE INVENTION

An embodiment of the present invention is described with reference to the drawings. Note that the embodiment described below exemplifies the present invention. The present invention is not limited to the following embodiment.

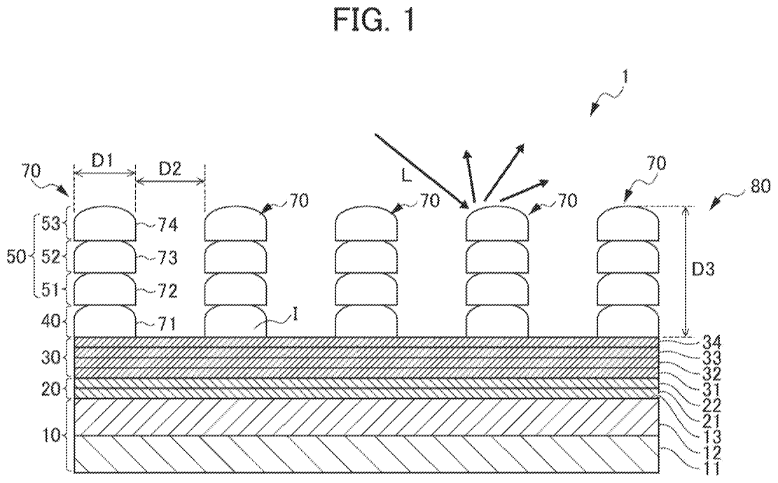

First, a printed matter 1 printed by an inkjet printing method according to this embodiment is described. FIG. 1 is a sectional view of the printed matter 1 printed by the inkjet printing method according to this embodiment.

The printed matter 1 includes a print target 10 and a printed surface 80. The printed surface 80 includes foundation layers 20, color layers 30, an unlevel layer 40 and unlevel layers 51, 52 and 53 that are three unlevel layers 50. The inkjet printing method uses active energy ray curable ink, which allows droplets to be cured by irradiation with UV (ultraviolet rays) or EB (electron beams). This embodiment uses UV curable ink, which allows droplets to be cured by irradiation with UW, as the active energy ray curable ink.

The print target 10 includes irregularities (not shown) on its surface 13. The print target 10 may be, for example, an instrument panel of an automobile or the like. In this embodiment, an instrument panel of an automobile is exemplified and description is made.

The print target 10 includes a base material 11 and a surface skin 12 that is made of resin and is formed on the base material 11. On the surface skin 12, irregularities are formed on its surface 13. Accordingly, an inkjet head 121 of an inkjet printing apparatus 100 described later cannot be made close to the surface 13 in comparison with a case of a flat print target. On the print target 10 in this embodiment, a printing area 14 that is to be printed has an elongated shape. The printing area 14 may encompass, for example, decorative shapes and the like simulating stitched seams and piping, which are provided for an instrument panel.

The foundation layers 20 are layers that are substantially flat and are printed in order to facilitate coloring of UV curable ink. The foundation layers 20 in this embodiment are monochromatic (white) layers and include foundation layers 21 and 22 arranged from the lower side to the upper side.

The color layers 30 are substantially flat layers. The color layers 30 in this embodiment are monochromatic (red) layers and include four color layers 31, 32, 33 and 34 arranged from the lower side to the upper side.

The unlevel layer 40 is provided on the color layer 34 and includes a plurality of bumps 71. One bump 71 is formed by discharging one droplet I of UV curable ink, has a substantially circular shape in plan view and has a diameter D1 substantially identical to the diameter of the droplet I of the UV curable ink. In the unlevel layer 40, the bumps 71 are arranged with at an interval D2 equal to or more than the diameter of the droplet I of the UV curable ink. The unlevel layer 40 is formed by decimated printing of discharging droplets I of the UV curable ink on the color layer 34 in a decimated manner. The unlevel layer 40 in this embodiment is a monochromatic (red) layer.

The unlevel layer 51 includes a plurality of bumps 72 made of the IV curable ink. One bump 72 is formed by discharging one droplet I of the UV curable ink. The bumps 72 are arranged on the respective bumps 71 of the unlevel layer 40. The unlevel layer 51 is formed by overlaying the droplets I of the UV curable ink on the respective bumps 71. In this embodiment, the unlevel layer 51 is a monochromatic (red) layer.

The unlevel layer 52 includes a plurality of bumps 73 made of the UV curable ink. One bump 73 is formed by discharging one droplet I of the UV curable ink. The bumps 73 are arranged on the respective bumps 72 of the unlevel layer 51. The unlevel layer 52 is formed by overlaying the droplets I of the UV curable ink on the respective bumps 72. In this embodiment, the unlevel layer 52 is a monochromatic (red) layer.

The unlevel layer 53 includes a plurality of bumps 74 made of the UV curable ink. One bump 74 is formed by discharging one droplet I of the UV curable ink. The bumps 74 are arranged on the respective bumps 73 of the unlevel layer 53. The unlevel layer 53 is formed by overlaying the droplets I of the UV curable ink on the respective bumps 73 of the unlevel layer 52. In this embodiment, the unlevel layer 53 is a monochromatic (red) layer.

As shown in FIG. 1, a plurality of stacked bodies 70 made of the bumps 71 to 74 overlaid on the color layer 34 in a direction substantially orthogonal to the surface of the color layer 34 are formed on the print target 10. The printed matter 1 is configured to have height D3 that is the height of the stacked bodies 70 from the surface of the color layer 34 to the tops of the bumps 74 and has an average height Rc thereof having a predetermined value or more. The stacked bodies 70 are arranged with respect to the adjacent stacked bodies 70 at the interval D2 equal to or more than the diameter of the droplet I of the UV curable ink.

In the printed matter 1, the stacked bodies 70 adjacent to each other are arranged at the interval D2 equal to or more than the diameter D1 of the bumps 71, and the unlevel layers 50 are stacked on the unlevel layer 40. According to this configuration, as shown in FIG. 1, light L incident on the printed matter 1 can be scattered, which can reduce the gloss of the printed surface 80.

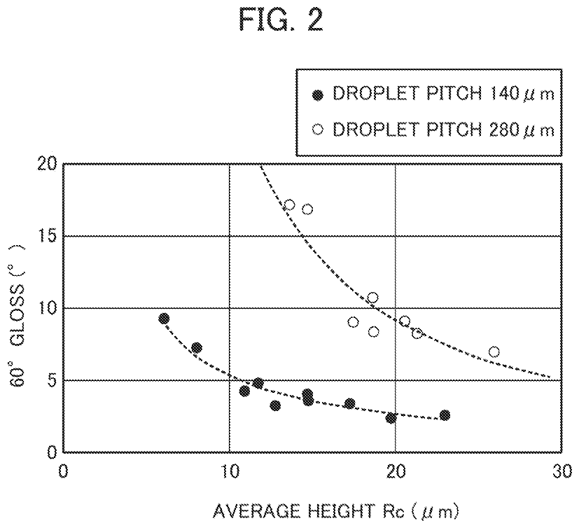

Next, the relationship between the 60° gloss of the printed matter obtained by printing using the UV curable ink I, the average height Rc indicating the surface roughness of the printed matter and the droplet pitch is described with reference to FIG. 2. The 60° gloss is a gloss level in a case where light is incident at an incident angle of 60°. The droplet pitch and the interval D2 in this specification mean the shortest distance from the periphery to the periphery of droplets adjacent to each other.

FIG. 2 shows the relationship between the average height Rc of the printed matter where the unlevel layers with a droplet pitch of 140 or 280 μm are formed, the 60° gloss and the droplet pitch. Note that in FIG. 2, the ordinate axis indicates the 60° gloss and the abscissa axis indicates the average height Rc (μm).

A method of creating a sample used for evaluating the 60° gloss of the printed matter is described. The sample was created by entirely applying the four color layer on a plain plate that is made of ABS resin and serves as a print target (hereinafter, an ABS plate) and then performing decimated printing through a first decimated printing step and a second decimated printing step, which are described later. The decimated printing was performed by inserting the ABS plate in an inkjet printing apparatus and making this plate apart from an inkjet head by about 10 mm. The number of times of decimated printing and timing of discharging droplets of UV curable ink from the inkjet head were changed and multiple samples were created. Specifically, the number of times of decimated printing was changed from 0 to 10. The timing of discharging droplets was adjusted to 140 or 280 μm. The decimated printing was performed using droplets of UV curable ink having a diameter of about 134 μm.

As shown in FIG. 2, for any of samples with droplet pitches of 140 and 280 μm, it can be confirmed that the larger the average height Rc was, the lower the 60° gloss was. That is, it can be confirmed that the larger the height D3 of the stacked bodies 70 of the printed matter 1 was, the lower the 60° gloss was.

As shown in FIG. 2, it can be confirmed that the sample with the droplet pitch of 140 μm was required to have a larger average height Rc to achieve the same 60° gloss than the sample with the droplet pitch of 280 μm. That is, the larger the droplet pitch is, the larger the average height Rc required to suppress the 60° gloss is. The smaller the droplet pitch is, the smaller the average height Rc requiring 60° gloss. If the droplet pitch is reduced, the average height Rc required to suppress the gloss is reduced. If the size of each droplet is large, the spread due to moistening after adherence to the print target becomes large, and droplets adjacent to each other are coupled and form a flat surface. As a result, the average height Rc of the printed surface 80 decreases. Accordingly, it is required to secure a droplet pitch equal to or larger than a predetermined interval according to the size of each droplet and the distance from the inkjet head to the surface of the print target in order not to prevent the droplets from being coupled to each other. The average height Rc is required to be adjusted according to the secured droplet pitch.

In this embodiment, the print target 10 having irregularities on the surface 13 is printed. Consequently, the inkjet head 121 cannot be made close in comparison with the case of printing on a print target having a flat surface. Accordingly, the sizes of droplets I of the UV curable ink are increased so as to prevent the landing positions of the droplets I of the UV curable ink from deviating. Furthermore, in this embodiment, large-sized droplets are prevented from being coupled with each other by discharging the droplets of the UV curable ink so as to arrange the bumps 71 at the interval D2 equal to or larger than the diameter of the UV curable ink. The average height Rc is increased by stacking the bumps 72 to 74 on the bumps 71. As a result, the gloss of the printed surface 80 is reduced.

For example, as shown in FIG. 2, in the case where the diameter of the droplets I of the UV curable ink was 134 μm, it can be confirmed that with the interval D2 of 140 μm, the average height Rc of 11 μm or more allows the gloss of 60° to be about 5.0 or less.

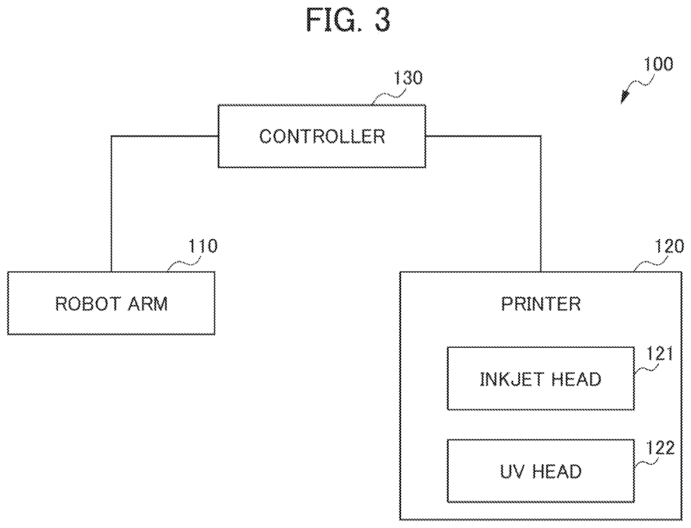

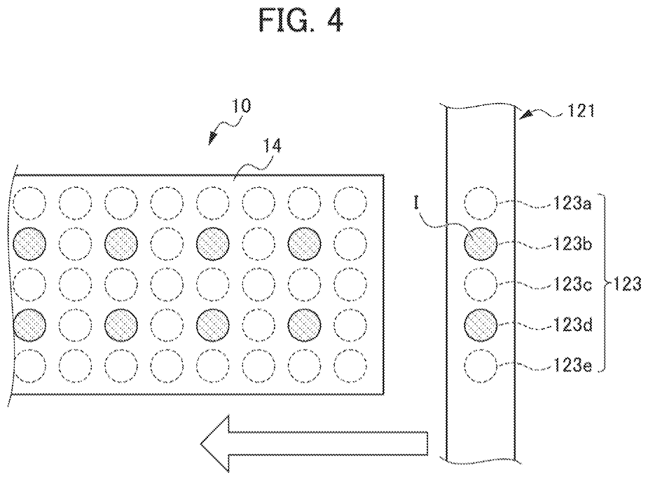

Next, the inkjet printing apparatus 100 used for the inkjet printing method according to this embodiment is described with reference to FIGS. 3 and 4. FIG. 3 is a block diagram showing the electric configuration of the inkjet printing apparatus 100. FIG. 4 is a plan view of the inkjet head 121 of the inkjet printing apparatus 100 and the print target 10, and shows the positions of the inkjet head 121 and the print target 10 at the time of starting a first decimated printing step described later. Note that in FIG. 4, circles forming a dot pattern indicate locations to which the droplets I of the UV curable ink are discharged, and circles forming a dot pattern on the inkjet head 121 indicate nozzles 123 from which the droplets I of the UV curable ink are discharged. In FIG. 4, illustration of a UV head 122 is omitted.

The inkjet printing apparatus 100 includes a robot arm 110, a printer 120 and a controller 130.

The robot arm 110 is configured to be capable of holding the print target 10. The robot arm 110 is configured to be movable on the basis of a signal from the controller 130 while holding the print target 10.

The printer 120 includes the inkjet head 121 and UV heads 122a and 122b. The inkjet head 121 is a member having an elongated shape. The inkjet head 121 includes the nozzles 123 for discharging droplets I of the UV curable ink. As shown in FIG. 4, the nozzles 123 are arranged at intervals in the longitudinal direction of the inkjet head 121. Note that FIG. 4 only shows some of nozzles 123 of the inkjet head 121.

The UV heads 122a and 122b have elongated shapes and emit UV serving as active energy rays. The UV head 122a is arranged on one side in the lateral direction of the inkjet head 121. The UV head 122b is arranged on the other side in the lateral direction of the inkjet head 121.

The controller 130 is a computer that includes, for example, a CPU and a memory, and controls the operations of the robot arm 110 and the printer 120.

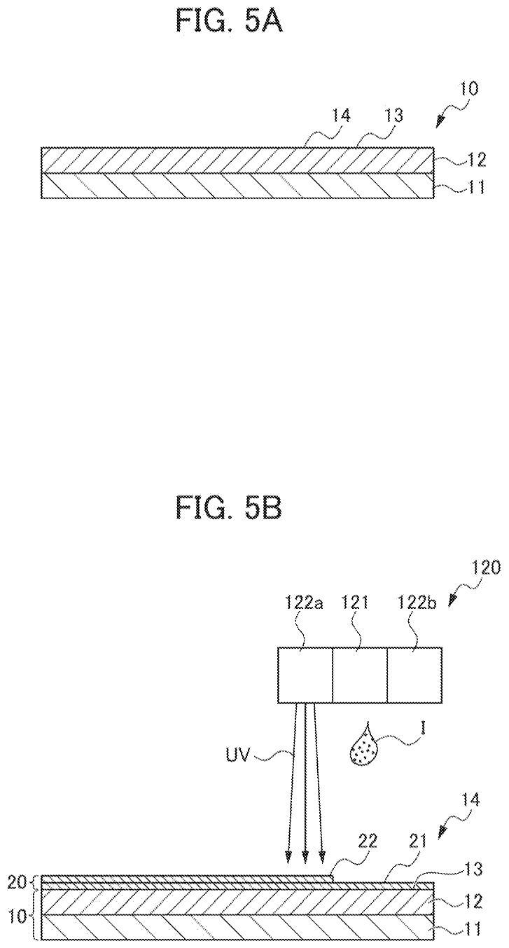

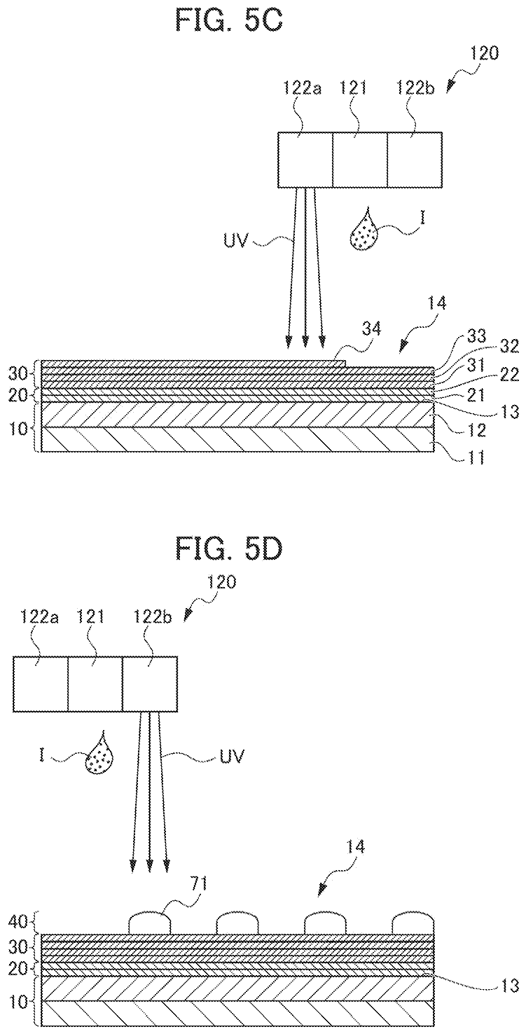

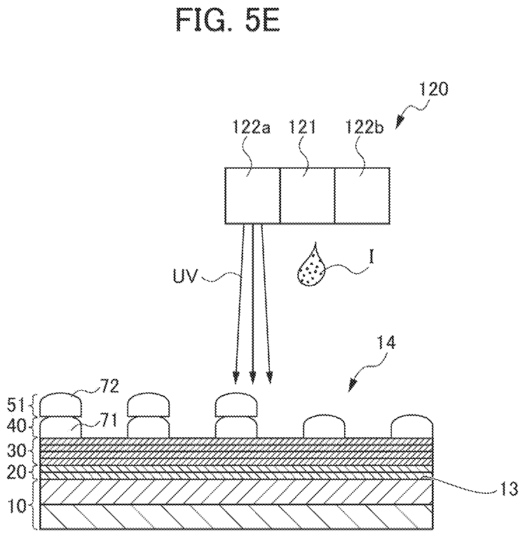

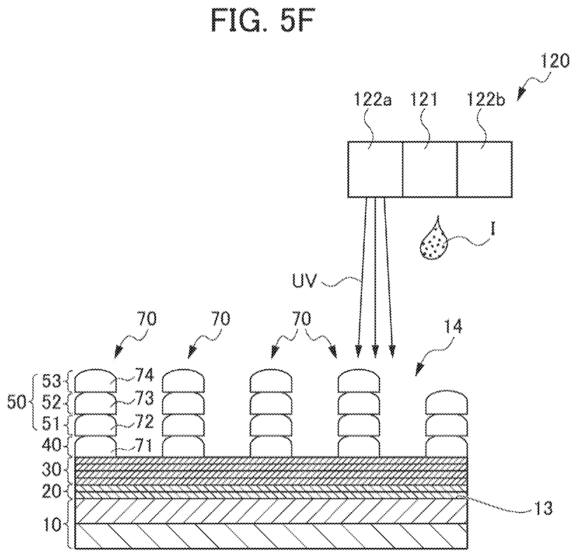

Next, the inkjet printing method according to this embodiment is described with reference to FIGS. 4 to 68. FIG. 5A is a sectional view of a print target 10 before printing. FIG. 5B is a sectional view of the print target 10 on which the foundation layers 20 are printed. FIG. 5C is a sectional view of the print target 10 on which color layers 30 are printed. FIG. 5D is a sectional view of the print target 10 on which an unlevel layer 40 is printed in a decimated manner. FIG. 5E is a sectional view of the print target 10 on which an unlevel layer 51 is printed in a decimated manner. FIG. 5F is a sectional view of the print target 10 on which an unlevel layer 53 is printed in a decimated manner.

The inkjet printing method according to this embodiment includes: a first normal printing step of forming the foundation layer 20 on the print target 10; a second normal printing step of forming at least one color layer 30 on the print target 10 (normal printing step); a first decimated printing step of performing decimated printing so as to form one unlevel layer 40 on the color layer 30; and a second decimated printing step of performing decimated printing so as to stack three unlevel layers 50 on the bumps 71 of the unlevel layer 40. In this embodiment, the case of using the inkjet printing apparatus 100 is exemplified and described.

First, the controller 130 controls the robot arm 110 and causes the robot arm 110 to hold the print target 10 and to move the print target 10 so that the printing area 14 of the print target 10 can be included in the printable area of the inkjet head 121. As shown in FIG. 4, the controller 130 then controls the robot arm 110 and the printer 120 to adjust the position so that the lateral direction of the printing area 14 of the print target 10 can be substantially parallel to the direction in which the nozzles 123 of the inkjet head 121 are arranged. At this time, if the inkjet head 121 moves in the direction of an arrow in FIG. 4, the controller 130 adjusts the positions of the print target 10 and the inkjet head 121 so that the discharge ports (not shown) of the nozzles 123 can face the printing area 14.

Next, in the first normal printing step, the two foundation layers 20 are formed on the print target 10. Specifically, through control by the controller 130, the printer 120 discharges droplets I of the UV curable ink on the surface 13 of the print target 10 shown in FIG. 5A while moving from the end on one side in the longitudinal direction of the printing area 14 (the right in FIGS. 5A to 5F) to the end on the other side in the longitudinal direction (the left in FIGS. 5A to 5F). At this time, the printer 120 emits UV from the UV head 122b and irradiates the droplets I of the UV curable ink adhering to the print target 10 and cures the droplets I of the UV curable ink.

After the droplets I of the UV curable ink adhering to the end of the other side in the longitudinal direction of the printing area 14 is irradiated with UV, the controller 130 changes the movement direction of the printer 120 by 180°. The controller 130 then discharges the droplets I of the IV curable ink from the inkjet head 121 while moving the printer 120 from the end on the other side in the longitudinal direction of the printing area 14 to the end on the one side in the longitudinal direction. At this time, as shown in FIG. 5B, UV is emitted from the UV head 122a to the droplets I of the UV curable ink adhering to the print target 10, and the droplets I of the UV curable ink are cured. Reciprocating movement of the printer 120 from the end on the one side in the longitudinal direction of the printing area 14 to the end on the other side in the longitudinal direction forms the two foundation layers 20. Note that in the first normal printing step, monochromatic (white) ink is used as UV curable ink.

Next, in a second normal printing step (normal printing step), at least one color layer 30 is formed on the print target 10. Specifically, similar to the case of forming the foundation layers 20, through control by the controller. 130, the printer 120 discharges the droplets I of the UV curable ink and emits UV while moving between the end on the one side in the longitudinal direction of the printing area 14 and the end on the other side in the longitudinal direction. As shown in FIG. 5C, reciprocating movement of the printer 120 from the end on the one side in the longitudinal direction of the printing area 14 to the end on the other side in the longitudinal direction forms the four color layers 30 on the foundation layer 22. Note that in the second normal printing step, monochromatic (red) ink is used as UV curable ink.

Next, a first decimated printing step discharges the droplets I of the UV curable ink so as to form, on the color layer 34, the unlevel layer 40 where the bumps 71 are arranged at the interval D2 equal to or more than the diameter of the droplets I of the UV curable ink. Preferably, the sizes of the droplets I of the UV curable ink range from 35 to 45 pL in a case where the print target 10 is an instrument panel or the like having irregularities on the surface 13, for example.

In the first decimated printing step, as shown in FIG. 5D, through the control by the controller 130, the printer 120 discharges a droplet I of the UV curable ink that has a constant amount from the inkjet head 121 at constant timing while moving from the end on the one side in the longitudinal direction of the printing area 14 to the end on the other side in the longitudinal direction. The printer 120 then emits UV from the UV head 122b and irradiates the UV curable ink adhering to the color layer 30 and cures the UV curable ink to form the bump 71. Thus, one-way movement of the printer 120 from the end on the one side of the printing area 14 to the end on the other side of the printing area 14 can form one unlevel layer 40 where bumps 71 are arranged at the interval D2 equal to or more than the diameter of the droplet I of the UV curable ink in the longitudinal direction of the printing area 14.

At this time, the printer 120 discharges the droplets I of the UV curable ink from predetermined nozzles among the nozzles 123 arranged in the longitudinal direction. In this embodiment, the predetermined nozzles that discharge the droplets I of the UV curable ink are selected so that nozzles 123 that do not discharge even one droplet I of the UV curable ink are positioned between the adjacent nozzles 123 that discharge the droplets I of the UV curable ink. For example, as shown in FIG. 4, the droplets I of the UV curable ink are discharged from the nozzles 123b and 123d among the nozzles 123a to 123e of the inkjet head 121. The droplets I of the UV curable ink are not discharged from the nozzles 123a, 123c or 123e. That is, nozzles 123 from which the droplets I of the UV curable ink are discharged, and nozzles 123 from which the droplets I of the UV curable ink are not discharged are arranged alternately. Accordingly, even in a case of discharging the droplets I of the UV curable ink at the same time from all the nozzles 123 from which the droplets I of the UV curable ink are to be discharged, the unlevel layer 40 can be formed where the bumps 71 adjacent to each other also in the lateral direction of the printing area 14 are arranged at the interval D2 equal to or more than the diameter of the droplets I of the UV curable ink. Note that in the first decimated printing step, monochromatic (red) ink is used as UV curable ink.

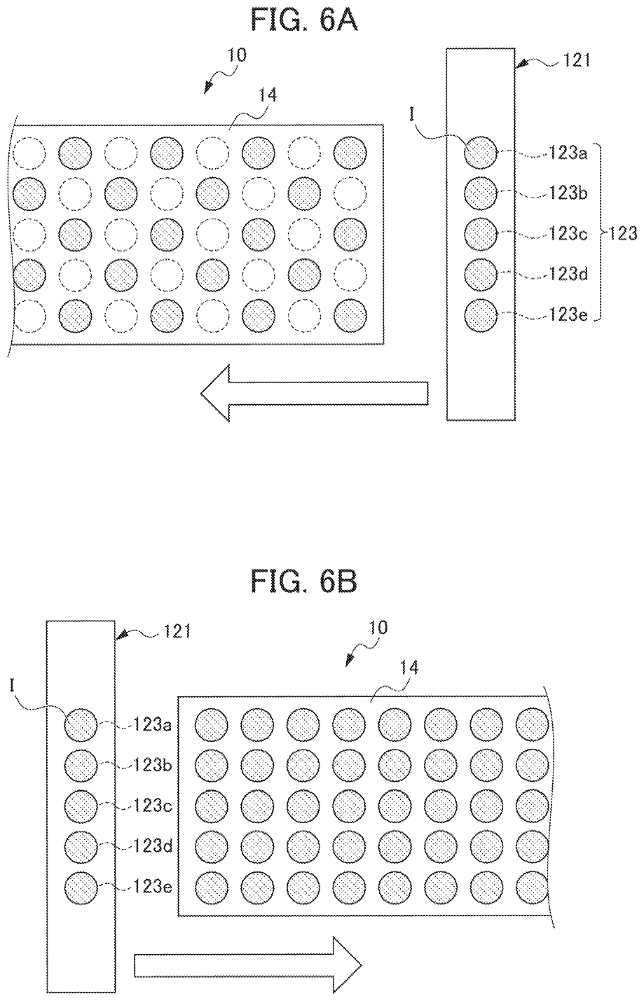

Here, to describe the difference between the inkjet printing method in this embodiment and the conventional art, an inkjet printing method according to the conventional art is described with reference to FIGS. 6A and 6B.

FIGS. 6A and 6B are plan views of the inkjet head 121 and the print target 10. FIG. 6A shows a state before formation of the unlevel layer made of UV curable ink on the print target 10 is started by the inkjet printing method according to the conventional art. FIG. 6B shows the state at the middle of formation of the unlevel layer made of UV curable ink by the inkjet printing method according to the conventional art. In FIGS. 6A and 6B, illustration of the UV head 122 is omitted. In FIG. 6A, circles forming a dot pattern on the print target 10 indicate locations to which the droplets I of the UV curable ink are discharged during one-way movement of the inkjet head 121, and circles forming a dot pattern on the inkjet head 121 indicate nozzles 123 from which the droplets I of the UV curable ink are discharged. In FIG. 6B, circles forming a dot pattern indicate locations to which the droplets I of the UV curable ink are discharged after reciprocating movement of the inkjet head 121, and circles forming a dot pattern on the inkjet head 121 indicate nozzles 123 from which the droplets I of the UV curable ink are discharged.

As shown in FIG. 6A, the inkjet printing method of the conventional art discharges the droplets I of the UV curable ink using all the nozzles 123a to 123e that face the printing area 14. Specifically, the droplets I of the UV curable ink are discharged alternately from a set of nozzles 123a, 123c and 123e and a set of the nozzles 123b and 123d with time deviation. As a result, after one-way movement of the inkjet head 121 from the end on one side of the printing area 14 to the end on the other side, a state is achieved where the bumps are arranged at an interval equal to or more than the diameter of the droplets I of the UV curable ink in the lateral direction and the longitudinal direction of the printing area 14. While the inkjet head 121 is returned from the end on the other side of the printing area 14 to the end on the one side, the droplets I of the UV curable ink are alternately discharged from the set of nozzles 123a, 123c and 123e and the set of nozzles 123b and 123d with time deviation toward spaces between the bumps formed in the printing area 14. As a result, one unlevel layer is formed where the interval D2 between the bumps adjacent to each other is less than the diameter D1 of the bumps. However, according to the conventional art shown in FIGS. 6A and 6B, the interval D2 is small. Accordingly, there is a possibility that with certain sizes of the droplets I of the UV curable ink, droplets I of the UV curable ink that are adjacent to each other are coupled to each other. According to the conventional art shown in FIGS. 6A and 68, in order to form one unlevel layer in the printing area 14, the printer 120 is required to move in a reciprocating manner between the end on the one side of the printing area 14 and the end on the other side.

Meanwhile, according to this embodiment, the droplets I of the UV curable ink are discharged so that the bumps 71 adjacent to each other can be arranged at the interval D2 equal to or more than the droplet I of the UV curable ink. Accordingly, the discharged droplets I of the UV curable ink are prevented from being coupled with each other. As described above, the one unlevel layer 40 can be formed by one-way movement of the printer 120.

Next, in a second decimated printing step, at least one unlevel layer 50 is stacked on the bumps 71 of the unlevel layer 40 by discharging the droplets I of the UV curable ink in an overlaid manner.

In the second decimated printing step, as shown in FIG. 5E, through the control by the controller 130, the printer 120 discharges a droplet I of the UV curable ink from the inkjet head 121 on the bumps 71 of the unlevel layer 40 while moving from the end on the other side in the longitudinal direction of the printing area 14 to the end on the one side in the longitudinal direction. That is, the printer 120 discharges the droplets I of the UV curable ink having the same amount as that in the first decimated printing step from the inkjet head 121 at the same timing so as to overlay the droplets I of the UV curable ink on the bumps 71. The printer 120 then emits UV from the WV head 122a to the droplets I of the UV curable ink discharged from the UV head 122a to the bumps 71. Thus, one-way movement of the printer 120 from the end on the other side of the printing area 14 to the end on the one side of the printing area 14 can form the unlevel layer 51 where bumps 71 are arranged at the interval D2 equal to or more than the diameter of the droplet I of the UV curable ink on the unlevel layer 40.

After the UV head 122a emits UV to the droplets I of the UV curable ink adhering to the end of the one side in the longitudinal direction of the printing area 14, the controller 130 changes the movement direction of the printer 120 by 180°. The controller 130 then controls the printer 120 to repeat the operation of forming the unlevel layer 40 and the unlevel layer 51 described above. Accordingly, as shown in FIG. 5F, the droplets I of the UV curable ink are discharged on the bumps 72 of the unlevel layer 51 and cured to make the unlevel layers 73 and 74, thus forming the stacked bodies 70. After one reciprocating movement between the end on the one side of the printing area 14 and the end on the other side, the unlevel layers 52 and 53 are formed on the unlevel layer 51. Consequently, the printed surface 80 that has a high average height Rc and reduced gloss can be effectively formed. Note that in the second decimated printing step, monochromatic (red) ink is used as UV curable ink.

The inkjet printing method according to this embodiment can exert the following advantageous effects.

The inkjet printing method according to this embodiment is an inkjet printing method of printing by discharging droplets I of UV curable ink onto a print target 10 from an inkjet head 121, the method including: a normal printing step of forming at least one color layer 30 on the print target 10; a first decimated printing step of discharging the droplets I of the UV curable ink so as to form, on the color layer 30, one unlevel layer 40 where a plurality of bumps 71 are arranged at an interval equal to or more than a diameter of each of the droplets I of the UV curable ink; and a second decimated printing step of stacking, on the bumps 71 of the unlevel layer 40, at least one unlevel layer 51 formed by discharging droplets I of the UV curable ink so as to be overlaid thereon.

Thus, the droplets I of the UV curable ink are discharged to the print target 10 so that the interval D2 between the bumps 71 adjacent to each other can be equal to or more than diameter of the droplets I of the UV curable ink. Accordingly, the interval D2 according to the sizes of the droplets I of the UV curable ink can be secured. Consequently, even in a case of increasing the sizes of the droplets I of the UV curable ink, the printed surface 80 having irregularities can be formed more securely. The droplets I of the UV curable ink are discharged so as to stack the bumps 72 on the bumps 71. Accordingly, the average height Rc can be effectively increased. Consequently, the printed surface 80 having a reduced gloss can be effectively formed on the print target 10 having concaves on the surface 13.

In the inkjet printing method according to this embodiment, the printing area 14 of the print target 10 has an elongated shape, and the UV curable ink I is discharged to the printing area 14 while the inkjet head 121 is moved in the longitudinal direction of the printing area 14.

Accordingly, only by moving the inkjet head 121 in one direction, the printed surface 80 that includes the color layers 30 and the unlevel layers 40, 51, 52 and 53 can be easily formed.

In the inkjet printing method according to this embodiment, the inkjet head 121 is movable in a reciprocating manner in the longitudinal direction, the first decimated printing step forms the one unlevel layer 40 while moving the inkjet head 121 in the longitudinal direction in a one-way manner, and the second decimated printing step forms the one unlevel layer 50 every movement of the inkjet head 121 in the longitudinal direction in the one-way manner.

Accordingly, the one unlevel layer 40 can be formed by one-way movement of the inkjet head 121. The two unlevel layers 50 are stacked on the unlevel layer 40 by reciprocating movement of the inkjet head 121. Consequently, the cycle time can be improved.

In the inkjet printing method according to this embodiment, the inkjet head 121 includes a plurality of nozzles 123 that are arranged in parallel in a predetermined direction and discharge the active energy ray curable ink, and the first decimated printing step and the second decimated printing step each use a predetermined number of the nozzles 123 among the plurality of nozzles 123 to form the unlevel layers 40 and 50 while moving the inkjet head 121 in the longitudinal direction of the printing area 14 in a state where the predetermined direction is substantially parallel to a lateral direction of the printing area 14.

Accordingly, the printed surface 80 that includes the unlevel layers 40 and 50 can be formed without moving the inkjet head 121 in the lateral direction.

In the inkjet printing method according to this embodiment, the normal printing step, the first decimated printing step and the second decimated printing step each include using a robot arm 110 capable of holding the print target 10 and moving the robot arm 110 holding the print target 10 such that the area on which the inkjet head 121 is able to print covers the printing area.

Accordingly, not only the inkjet head 121 but also the print target 10 can be moved, thereby allowing the UV curable ink I to be landed on the print target 10 more accurately.

In the inkjet printing method according to this embodiment, the UV curable ink is monochromatic.

Accordingly, the monochromatic property allows the unlevel layers 40 and 50 to be formed by moving the inkjet head 121 in only one direction.

In the inkjet printing method according to this embodiment, the print target 10 is an instrument panel of an automobile.

Accordingly, the printed surface 80 having a low gloss level can be effectively formed even on a surface having large irregularities, such as an instrument panel.

The embodiment of the present invention has thus been described above. However, the present invention is not limited to the embodiment described above. Appropriate modification may be allowed.

The printed surface 80 formed by the inkjet printing method according to the embodiment described above includes the foundation layers 20, the color layers 30, the unlevel layer 40 and the unlevel layers 50. However, the foundation layers 20 are not necessarily included.

The number of color layers 30 formed by the inkjet printing method according to the embodiment described above is four. However, the number of layers is not specifically limited only if at least one layer is formed. For example, the number of color layers 30 to be formed may be three or less or five or more.

The number of unlevel layers 50 formed by the inkjet printing method according to the embodiment described above is three. However, the number of layers is not specifically limited only if at least one layer is formed. For example, the number of unlevel layers 50 may be two or three or five or more. The number of unlevel layers 50 can be appropriately adjusted according to the intended gloss level, the diameter D1 of the droplets I of the UV curable ink and the interval D2 between the bumps 71.

The inkjet printing method according to the embodiment described above adopts the monochromatic active energy ray ink. However, the type of ink is not specifically limited.

### EXPLANATION OF REFERENCE NUMERALS

10 Print target
30, 31, 32, 33, 34 Color layer
40, 50, 51, 52, 53 Unlevel layer
71, 72, 73, 74 Bump
121 Inkjet head
D2 Interval
I Droplet of UV curable ink

What is claimed is:

1. An inkjet printing method for printing by discharging droplets of active energy ray curable ink onto a print target from an inkjet head, the method comprising:
a normal printing step of forming at least one color layer on the print target;
a first decimated printing step of discharging the droplets of the active energy ray curable ink so as to form, on the color layer, one unlevel layer having a plurality of bumps arranged at an interval equal to or more than a diameter of each of the droplets of the active energy ray curable ink; and
a second decimated printing step of stacking, on the bumps of the unlevel layer, at least one unlevel layer formed by discharging droplets of the active energy ray curable ink such that the droplets are overlaid on the bumps.

2. The inkjet printing method according to claim 1,
wherein a printing area of the print target has an elongated shape, and
the active energy ray curable ink is discharged to the printing area while the inkjet head is moved in a longitudinal direction of the printing area.

3. The inkjet printing method according to claim 2,
wherein the inkjet head is movable in a reciprocating manner in the longitudinal direction,
the first decimated printing step includes forming the one unlevel layer while moving the inkjet head in the longitudinal direction in a one-way manner, and
the second decimated printing step includes forming the one unlevel layer every movement of the inkjet head in the longitudinal direction in the one-way manner.

4. The inkjet printing method according to claim 2,
wherein the inkjet head includes a plurality of nozzles that are arranged in parallel in a predetermined direction and discharge the active energy ray curable ink, and
the first decimated printing step and the second decimated printing step each include using a predetermined number of the nozzles among the plurality of nozzles to form the unlevel layer while moving the inkjet head in the longitudinal direction of the printing area in a state where the predetermined direction is substantially parallel to a lateral direction of the printing area.

5. The inkjet printing method according to claim 2, wherein the normal printing step, the first decimated printing step and the second decimated printing step each include using a robot arm capable of holding the print target and moving the robot arm holding the print target such that the area on which the inkjet head is able to print covers the printing area.

6. The inkjet printing method according to claim 1, wherein the active energy ray curable ink is monochromatic.

7. The inkjet printing method according to claim 1, wherein the print target is an instrument panel of an automobile.

8. An inkjet printing apparatus, comprising:
a printer configured to perform printing by discharging active energy ray curable ink to a print target; and
a controller configured to control the printer,
wherein the controller controls operation of the printer to: form at least one color layer on the print target; discharge the droplets of the active energy ray curable ink so as to form, on the color layer, one unlevel layer having a plurality of bumps arranged at an interval equal to or more than a diameter of each of the droplets of the active energy ray curable ink; and stack, on the bumps of the unlevel layer, at least one unlevel layer formed by discharging droplets of the active energy ray curable ink such that the droplets are overlaid on the bumps.
